(19) United States
(12) Patent Application Publication
(10) Pub. No.: US 2007/0177777 A1
(43) Pub. Date: Aug. 2, 2007

(54) Removable storage device and authentication method

(76) Inventors: Takeshi Funahashi, Saitama (JP); Toshiro Nagashima, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 11/599,006

(22) Filed: Nov. 13, 2006

(30) Foreign Application Priority Data
Dec. 26, 2005 (JP) JP 2005-372517

(51) Int. Cl. G06K 9/00

(52) U.S. Cl. 382/124

(57) ABSTRACT

A removable storage device includes: an interface which is defined by a predetermined format and to which an external device is connectable; a data storage part in which data is stored and data is exchanged between the data storage part and the external device connected to the interface; a fingerprint reading sensor configured to read a fingerprint; authentication method selection unit for selecting an authentication method; first authentication means for verifying whether the fingerprint read by the fingerprint reading sensor is matched with a fingerprint registered beforehand by comparing them in accordance with the selection by the authentication method selection means; second authentication means for verifying whether character and symbol information extracted based on traces drawn on the fingerprint reading sensor is matched with registered character and symbol information registered beforehand by comparing them in accordance with the selection by the authentication method selection means; and determination means for determining whether to grant the external device access to the data storage part in accordance with an authentication result by the first authentication means or/and an authentication result by the second authentication means.

### CROSS REFERENCES TO RELATED APPLICATIONS

The present invention contains subject matter related to Japanese Patent Application JP 2005-372517 filed in the Japanese Patent Office on Dec. 26, 2005, the entire contents of which being incorporated herein by reference.

### BACKGROUND OF THE INVENTION

1. Field of the Invention

The present invention relates to a removable storage device which is connected to an external device through a predetermined interface and grants or denies the external device access to a storage part in which data is stored in accordance with a predetermined authentication result, and to an authentication method.

2. Description of the Related Art

As for personal computer security including logon to a personal computer (PC), or network security via a network such as logon to a domain, it is increasingly difficult to maintain security according to password authentication based on human knowledge and memories. In recent years, various schemes of personal authentication using biometrics (biometric information) by means of a removable storage device are proposed.

Here, a removable storage device utilizing biometrics based on fingerprints will be described. In the removable storage device, a fingerprint template is registered in the device beforehand, a user's fingerprint is read when the device is used (when the device is connected to an external device (for example, a PC)), and the read fingerprint is compared with the fingerprint template to identify the fingerprint. Consequently, when personal authentication is determined, the PC is granted access to a storage in the removable storage device, or the PC is allowed to use a cryptographic key (for example, a private key according to public key cryptography) recorded in the removable storage device.

In addition, although the removable storage device like this is a device which can conduct personal authentication separately from the PC, the performance is varied depending on the use environment or the physical conditions of a person to be identified, and the device is not able to determine personal authentication from time to time because the device uses biometric authentication. In order to solve this problem, for a scheme to replace biometric authentication using the removable storage device, there is a technique that combines a password authentication scheme based on PC entry.

However, when the password authentication scheme using a PC is combined for use, it is likely to sneak Trojan horse or spyware into the PC to steal a password by another person. With this situation, the security level is resulted in the level of authentication based on password entry, and the adoption of biometric authentication is meaningless.

In addition, a so-called self-contained removable storage device is proposed which eliminates password authentication by means of a PC and completes authentication work only in the removable storage device (for example, see JP-A-2004-110382 (Patent Reference 1)).

### SUMMARY OF THE INVENTION

In the meantime, in order to avoid the case in which personal authentication becomes difficult to conduct while high security level is maintained, such a configuration is desirable that authentication based on biometrics is combined with authentication based on password entry.

Thus, it is desirable to provide a self-contained removable storage device which combines authentication based on biometrics with authentication based on password entry to conduct two authentications in the device and maintains the level of authentication based on biometrics as security level, and to an authentication method.

A removable storage device according to an embodiment of the invention includes: an interface which is defined by a predetermined format and to which an external device is connectable; a data storage part in which data is stored and data is exchanged between the data storage part and the external device connected to the interface; a fingerprint reading sensor configured to read a fingerprint; authentication method selection means for selecting an authentication method; first authentication means for verifying whether the fingerprint read by the fingerprint reading sensor is matched with a fingerprint registered beforehand by comparing them in accordance with the selection by the authentication method selection means; second authentication means for verifying whether character and symbol information extracted based on traces drawn on the fingerprint reading sensor is matched with registered character and symbol information registered beforehand by comparing them in accordance with the selection by the authentication method selection means; and determination means for determining whether to grant the external device access to the data storage part in accordance with an authentication result by the first authentication means or/and an authentication result by the second authentication means. The determination means grants the external device access to the data storage part when the first authentication means verifies that the fingerprint is matched, or/and the second authentication means verifies that character information is matched.

In addition, an authentication method according to an embodiment of the invention is an authentication method of authenticating whether data is allowed to be exchanged between a removable storage device having an interface defined by a predetermined format and a data storage part in which data is stored an external device connected to the interface, which includes: a step of selecting an authentication method; a first authentication step of verifying whether a fingerprint read by a fingerprint reading sensor which reads a fingerprint is matched with a fingerprint registered beforehand by comparing them in accordance with the selection in the step of selecting an authentication method; a second authentication step of verifying whether character and symbol information extracted based on traces drawn on the fingerprint reading sensor is matched with registered character and symbol information registered beforehand by comparing them in accordance with the selection by the authentication method selecting step; and a determining step of determining whether to grant the external device access to the data storage part in accordance with an authentication result by the first authentication step or/and an authentication result by the second authentication step. The determining step grants the external device access to the data storage part when the first authentication step verifies that the fingerprint is matched, or/and the second authentication step verifies that character information is matched.

In an embodiment of the invention, even when biometrics (fingerprint authentication) is not able to use, authentication work can be completed by another authentication method, and personal authentication can be conducted fully separated from the external device (self-contained type), whereby a significantly high security system can be provided.

### BRIEF DESCRIPTION OF THE DRAWINGS

FIG. 1 shows a block diagram depicting the configuration of a removable storage device according to an embodiment of the invention;

FIG. 2 shows a diagram depicting the configuration of a memory;

FIG. 3 shows a flow chart illustrative of registration procedures of various templates;

FIG. 4 shows a diagram depicting the configuration of a fingerprint sensor;

FIG. 5 shows a diagram depicting the appearance of graphical user interface menus for signature registration displayed on a monitor of an external device;

FIGS. 6A to 6D show diagrams depicting exemplary signatures drawn on the fingerprint sensor;

FIG. 7 shows a flow chart illustrative of authentication procedures; and

FIG. 8 shows a diagram illustrative of the configuration of a storage part in which a predetermined table is stored.

### DETAILED DESCRIPTION OF THE INVENTION

Hereinafter, the best mode of implementing an embodiment of the invention will be described in detail with reference to the drawings. In addition, it is without saying that an embodiment of the invention is not limited to the following examples, which can be freely modified within the scope not deviating from the teaching of an embodiment of the invention.

1. Overall Configuration

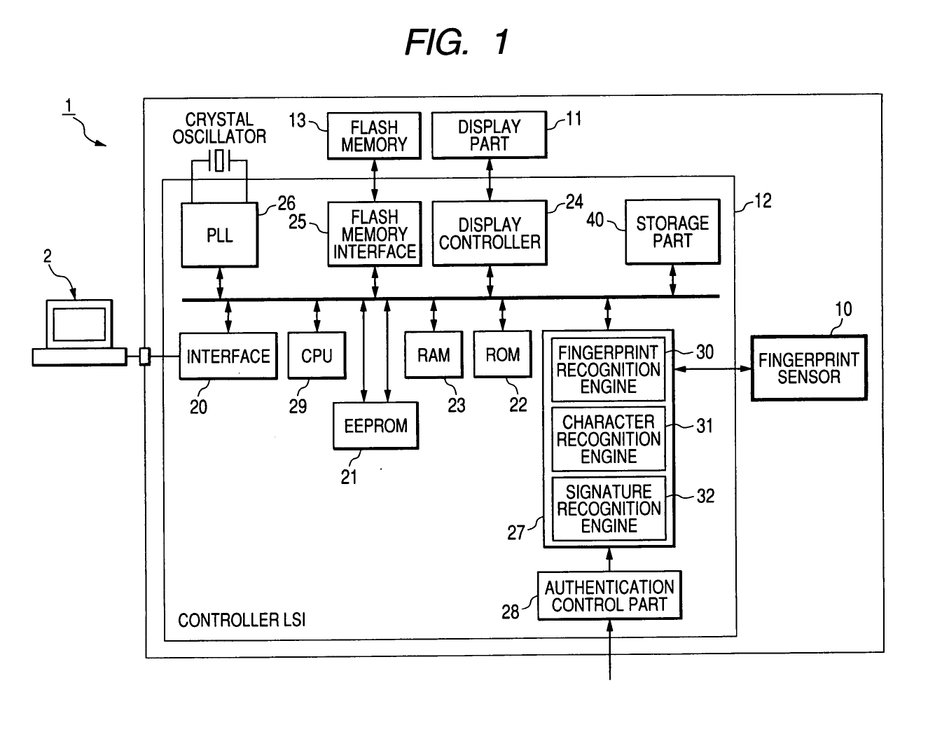

As shown in FIG. 1, a removable storage device 1 according to an embodiment of the invention has a fingerprint reading sensor (hereinafter, called a fingerprint sensor) 10 configured to read a fingerprint, a display part 11 configured of an LCD (Liquid Crystal Display) or an EL (electroluminescence) display, a controller LSI 12 configured to have an interface 20 which is defined by a predetermined format (for example, USB (Universal Serial Bus)), and a flash memory (hereinafter, called a memory) 13 configured of a NAND circuit for data storage, in which when an external device 2 is electrically connected through the interface 20, authentication work is conducted in the device 1 based on information inputted from the fingerprint sensor 10, and the external device 2 is granted access to the memory 13 in accordance with the authentication result. In addition, the removable storage device 1 is a device also provided with a PKI (Public Key Infrastructure) function, which also has a hardware token function.

Although the detail will be described later, the fingerprint sensor 10 is a sensor which can read fingerprints as well as can enter characters and symbols with the use of a text input pen etc. In addition, the text input pen may be detachably and externally mounted on the removable storage device 1. In addition, for example, the tip end part of the text input pen contacted with the fingerprint sensor 10 is fabricated, for example, with carbon contained material. In addition, for example, the entire text input pen is fabricated of a conductor.

On the display part 11, states and results are mainly displayed such as inputted characters and symbols, the “representation of inputted character from the fingerprint sensor”, the “fingerprint identification result”, and “data access from an external device”.

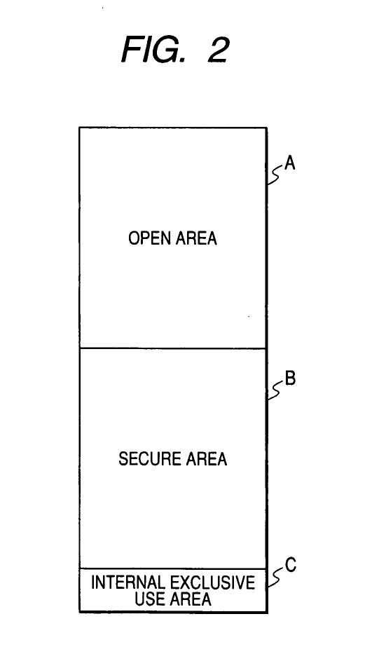

As shown in FIG. 2, the memory 13 is configured of an open area A to which the external device 2 is freely accessible, a secure area B to which the external device 2 is limited to have access, and an internal exclusive use area C to which the external device 2 is not able to have access, that is, only the removable storage device 1 itself is accessible. The secure area B is an area to which the external device 2 is granted access in accordance with the authentication result from authentication work, described later. For example, in the internal exclusive use area C, encrypted fingerprint templates and passwords are stored. In addition, the internal exclusive use area C is an area which is used when the capacity of an EEPROM 21, described later, is short.

2. Configuration of the Controller LSI 12

As shown in FIG. 1, in addition to the interface 20, the controller LSI 12 has the EEPROM 21 configured to store cryptographic keys (for example, private keys and public keys), a ROM 22 configured to store a predetermined program therein, a working RAM 23, a display controller 24 configured to control the display part 11, a memory interface 25 used for the memory 13, a PLL 26 configured to stabilize a predetermined clock generated by a crystal oscillator, and a plurality of the authentication engines, an authentication part 27 configured to conduct authentication work based on information supplied from the fingerprint sensor 10, an authentication control part 28 configured to control the authentication part 27 which switches the authentication engines, and a CPU 29 configured to control the entire controller LSI 12.

In the EEPROM 21, cryptographic keys are stored. In addition, the types of the cryptographic keys comply with RSA (Rivest Shamir Adleman), AES (Advanced Encryption Standard), DES (Data Encryption Standard) or other standards.

The display controller 24 controls images displayed on the display part 11. Although the detail will be described later, characters and symbols based on traces drawn on the fingerprint sensor 10 are displayed on the display part 11 under control of the display controller 24.

The memory interface 25 writes data in a predetermined area of the memory 13, or reads data out of a predetermined area of the memory 13 in accordance with access by the external device 2.

The PLL 26 creates clocks necessary for the interface 20 and the CPU 29 based on clocks supplied from the crystal oscillator.

Here, the configuration of the authentication part 27 will be described. The authentication part 27 has a fingerprint recognition engine 30 configured to recognize a fingerprint read by the fingerprint sensor 10 and to compare it with fingerprints stored in the EEPROM 21 or the internal exclusive use area C in the memory 13 (hereinafter, called fingerprint templates) for verifying whether they are matched under control of the CPU 29, a character recognition engine 31 configured to extract character and symbol information based on traces drawn on the fingerprint sensor 10 and to compare the extracted character and symbol information with character and symbol information stored in the EEPROM 21 or the internal exclusive use area C in the memory 13 (hereinafter, called character and symbol templates) for verifying whether they are matched, and a signature recognition engine 32 configured to extract trace (signature) information based on the traces drawn on the fingerprint sensor 10 and to compare the extracted signature information with trace information stored in the EEPROM 21 or the internal exclusive use area C in the memory 13 (hereinafter, called signature templates) for verifying whether they are matched.

3. Registration Work for Fingerprint Templates

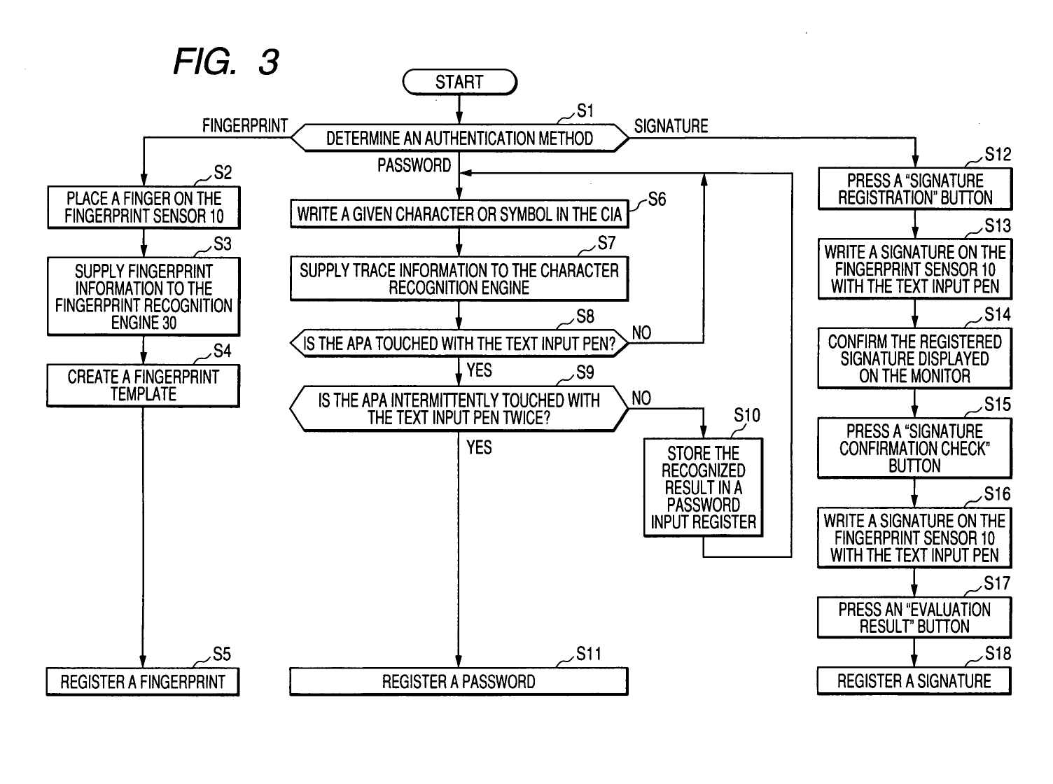

Here, the registration work for various templates will be described with reference to a flow chart shown in FIG. 3.

The authentication part 27 determines an authentication method of creating various templates based on a control signal supplied from the authentication control part 28 under control of the CPU 29 (Step S1). For the types of the authentication methods, there are an authentication method according to fingerprints, an authentication method according to passwords, and an authentication method according to signatures.

Here, the selection of the authentication methods will be described. For example, when the removable storage device 1 is electrically connected to the external device 2, a selection menu for the authentication methods is displayed on the monitor connected to the external device 2 in GUI (Graphical User Interface) display in accordance with a predetermined program, and a user selects one authentication method from the selection menu. The authentication control part 28 creates a control signal based on the selection, and supplies it to the authentication part 27. The authentication part 27 selects the fingerprint recognition engine 30, the character recognition engine 31 or the signature recognition engine 32 based on the control signal supplied from the authentication control part 28. The fingerprint sensor 10 supplies information read in the fingerprint recognition engine 30, the character recognition engine 31 or the signature recognition engine 32 being selected.

In addition, for example, such a configuration may be done in which the removable storage device 1 is provided with a switch which selects authentication methods to select one of the authentication methods by the selection done by the switch.

3-1. The Case in which the Authentication Method According to Fingerprints is Selected

A user places the user's finger on the fingerprint sensor 10 (Step S2). The fingerprint sensor 10 reads a fingerprint from the user's finger placed on the sensor, and supplies the read fingerprint information to the fingerprint recognition engine 30 (Step S3). The fingerprint recognition engine 30 creates a fingerprint template based on the supplied fingerprint information (Step S4). The fingerprint recognition engine 30 stores the created fingerprint template in the EEPROM 21, or encodes the created fingerprint template with a cryptographic key and stored the fingerprint template after encoded in the internal exclusive use area C in the memory 13 (Step S5).

As described above, the removable storage device 1 registers the fingerprint template according to the process steps of Steps S1 to S5.

3-2. The Case in which the Authentication Method According to Passwords is Selected

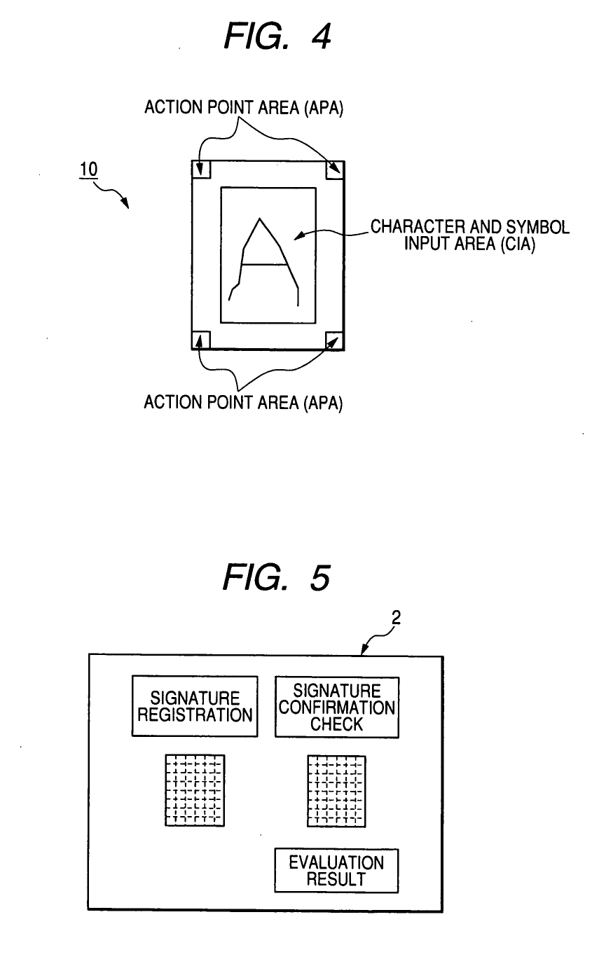

As shown in FIG. 4, the fingerprint sensor 10 is configured of an area sensor having a predetermined size, which is configured to have a character and symbol input area (CIA) in which traces are drawn, and action point areas (APA) which are used when a single character or a single symbol drawn in the CIA is defined. In addition, in FIG. 4, the places of the APA are disposed at four corners of the sensor, but they are not limited to four corners.

The user writes a given character or symbol in the CIA with the text input pen (Step S6). The fingerprint sensor 10 supplies trace information of the trace by the text input pen drawn on the sensor to the character recognition engine 31 (Step S7).

The character recognition engine 31 determines whether the user touches the APA with the text input pen (Step S8). When it is determined that the APA is not touched with the text input pen, the process step returns to Step S6, whereas when it is determined that the APA is touched with the text input pen, the process step goes to Step S9.

The character recognition engine 31 determines whether the user intermittently touches the APA with the text input pen twice (Step S9). When it is determined that the user does not intermittently touch it twice, the process step goes to Step S10, whereas when it is determined that the user intermittently touches it twice, the process step goes to Step S11.

At Step S10, the character recognition engine 31 interprets that a single character or a single symbol is inputted, performs character and symbol recognition, stores the recognized result in a password input register (the RAM 23), and displays the recognized result (a character or a symbol) on the display part 11. After that, the process steps of Steps S6 to S9 are repeated by the number of characters for a necessary password. In addition, the recognized characters and symbols are sequentially written in the password input register.

The user again writes a given character or symbol in the CIA, and touches the APA once with the text input pen when finishing writing a single character or a single symbol (Step S6 to Step S10).

The character recognition engine 31 interprets that the password is all inputted at Step S11, creates a character and symbol template from character and symbol information written in the password input register, and stores it as the password in the EEPROM 21, or encodes the created character and symbol template with a cryptographic key and stores the character and symbol template after encoded in the internal exclusive use area C in the memory 13. In addition, the password is actually converted to a hash value, and is registered in the EEPROM 21.

As described above, the removable storage device 1 registers the character and symbol template as the password according to the process steps of Step S1, and Steps S6 to S11.

3-3. The Case in which the Authentication Method According to Signatures is Selected

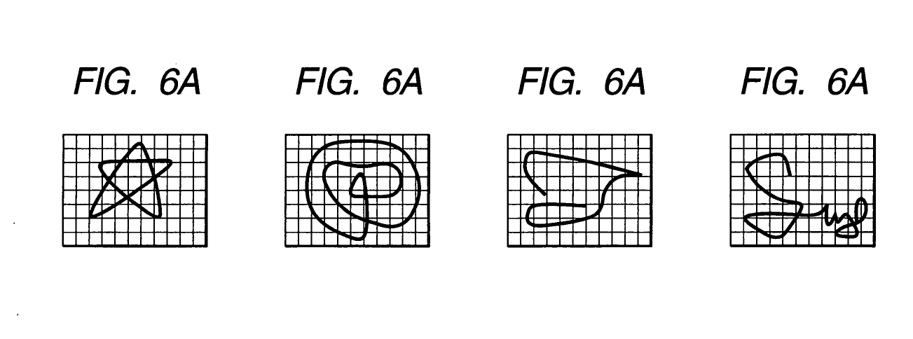

When the authentication method according to signatures is selected from the GUI selection menu displayed on the monitor of the external device 2, a GUI menu for signature registration as shown in FIG. 5 is displayed on the monitor of the external device 2. The user presses a “signature registration” button in the menu (Step S12). When the “signature registration” button is pressed, a signature registration is to be allowed.

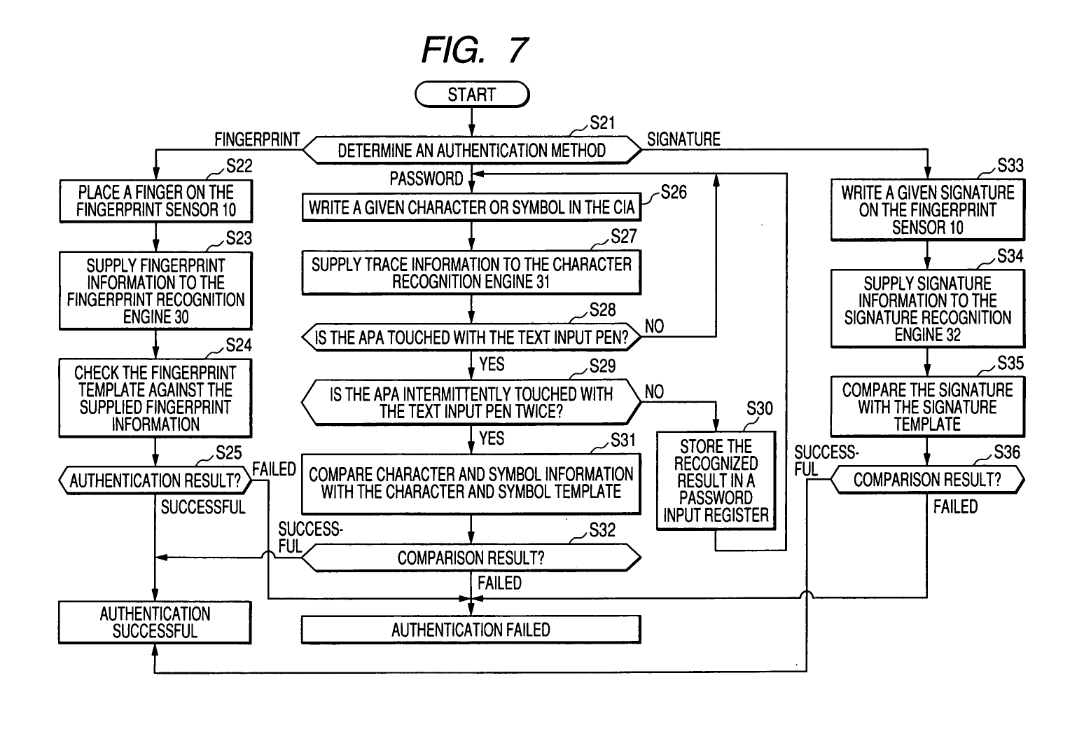

The user writes a given signature on the fingerprint sensor 10 with the text input pen (Step S13). For the signature, those signatures shown in FIGS. 6A to 6D are examples.

The fingerprint sensor 10 supplies signature information drawn on the sensor to the signature recognition engine 32.

The signature recognition engine 32 supplies the supplied signature information to the external device 2 through the interface 20. The external device 2 displays the supplied signature information on the monitor.

The user confirms the signature displayed on the monitor of the external device 2 (Step S14). After that, the user selects a “signature confirmation check” button (Step S15), again writes the signature on the fingerprint sensor 10 (Step S16), and presses an “evaluation result” button (Step S17).

In response to the press of the “evaluation result” button, the signature authentication engine 32 determines whether the signature information written at the process step of Step S13 is matched with the signature information written at the process step of Step S16. When the signature authentication engine 32 determines that the signature information is matched, it notifies the external device 2 about that, and stores the matched signature information as a signature template in the EEPROM 21, or encodes the signature template with a cryptographic key and stores it in the internal exclusive use area C in the memory 13 (Step S18). In addition, the signature template is actually converted to the hash value, and is registered in the EEPROM 21.

In addition, when the signature authentication engine 32 determines that the signature information is not matched, it notifies the external device 2 about that. When the signature information is not matched, the user again performs the process step of Step S16.

In addition, at the process step of Step S16, when it is determined that the signature information is matched, “OK” is displayed on the monitor of the external device 2, whereas when it is determined that the signature information is not matched, “NG” is displayed on the monitor of the external device 2.

As described above, the removable storage device 1 registers the character and symbol template according to the process steps of Step S1, and Steps S12 to S17.

4. Authentication Work

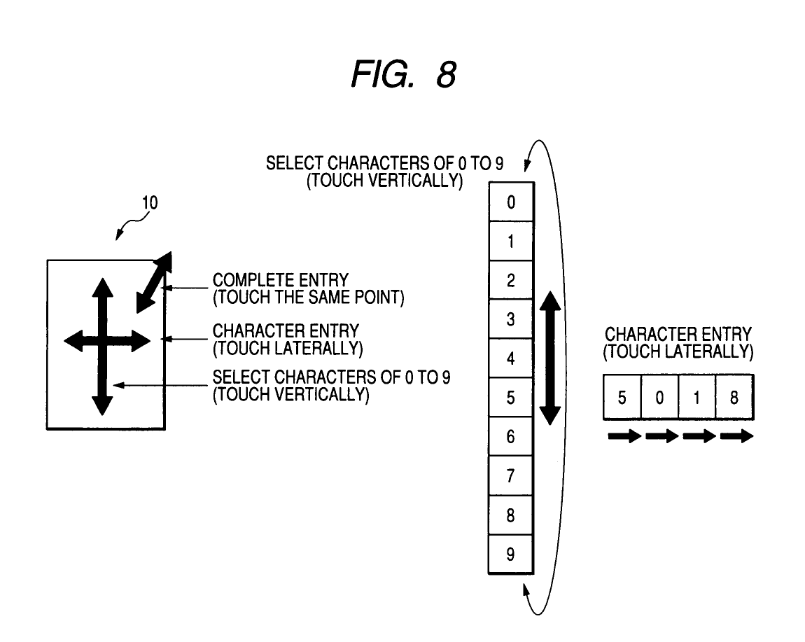

Next, authentication work based on various templates thus registered will be described with reference to a flowchart shown in FIG. 7.

The authentication part 27 determines various registered templates and the authentication method for authentication based on the control signal supplied from the authentication control part 28 under control of the CPU 29 (Step S21).

Here, the selection of the authentication methods will be described. For example, when the removable storage device 1 is electrically connected to the external device 2, a GUI selection menu for the authentication methods is displayed on the monitor connected to the external device 2 in accordance with a predetermined program, and a user selects one authentication method from the selection menu. The authentication control part 28 creates a control signal based on the selection, and supplies it to the authentication part 27. The authentication part 27 selects the fingerprint recognition engine 30, the character recognition engine 31 or the signature recognition engine 32 based on the control signal supplied from the authentication control part 28. The fingerprint sensor 10 supplies information read in the fingerprint recognition engine 30, the character recognition engine 31 or the signature recognition engine 32 being selected.

In addition, for example, such a configuration may be done in which the removable storage device 1 is provided with a switch which selects authentication methods to select one of the authentication methods by selection done by the switch.

4-1. The Case in which the Authentication Method According to Fingerprints is Selected

A user places the user's finger on the fingerprint sensor 10 (Step S22). The fingerprint sensor 10 reads a fingerprint from the user's finger placed on the sensor, and supplies the read fingerprint information to the fingerprint recognition engine 30 (Step S23). The fingerprint recognition engine 30 reads the fingerprint template registered at the process step of Step S5 from the EEPROM 21 or the internal exclusive use area C in the memory 13, and checks the fingerprint template against the supplied fingerprint information at the process step of Step S23 (Step S24).

The fingerprint recognition engine 30 determines whether the inputted fingerprint information is matched with the fingerprint template from the check work at the process step of Step S24 (Step S25).

As described above, the removable storage device 1 conducts fingerprint authentication according to the process steps of Steps S21 to S25.

4-2. The Case in which the Authentication Method According to Passwords is Selected

The user writes a given character or symbol in the CIA of the fingerprint sensor 10 with the text input pen (Step S26). The fingerprint sensor 10 supplies trace information of the trace by the text input pen drawn on the sensor to the character recognition engine 31 (Step S27).

The character recognition engine 31 determines whether the user touches the APA with the text input pen (Step S28). When it is determined that the APA is not touched with the text input pen, the process step returns to Step S26, whereas when it is determined that the APA is touched with the text input pen, the process step goes to Step S29.

At Step S29, the character recognition engine 31 determines whether the user intermittently touches the APA with the text input pen twice. When it is determined that the user does not intermittently touch it twice, the process step goes to Step S30, whereas when it is determined that the user intermittently touches it twice, the process step goes to Step S31.

At Step S30, the character recognition engine 31 interprets that a single character or a single symbol is inputted, performs character and symbol recognition, stores the recognized result in a password input register (the RAM 23), and displays the recognized result (a character or a symbol) on the display part 11. After that, the process steps of Steps S26 to S29 are repeated by the number of characters for a necessary password. In addition, the recognized characters and symbols are sequentially written in the password input register.

The user again writes a given character or symbol in the CIA, and touches the APA once with the text input pen when finishing writing a single character or a single symbol (Step S6 to Step S10).

At Step S31, the character recognition engine 31 interprets that the password is all inputted, and compares character and symbol information written in the password input register with the character and symbol template registered at the process step of Step S11 in the EEPROM 21 or the internal exclusive use area C in the memory 13. In addition, the hash value of the character and symbol information is actually compared with the hash value of the character and symbol template.

The character recognition engine 31 determines whether the character and symbol information is matched with the password from the comparison work at the process step of Step S31 (Step S32).

As described above, the removable storage device 1 conducts password authentication according to the process steps of Step S21 and Steps S26 to S32.

4-3. The Case in which the Authentication Method According to Signatures is Selected

The user writes a given signature on the fingerprint sensor 10 with the text input pen (Step S33).

The fingerprint sensor 10 supplies signature information drawn on the sensor to the signature recognition engine 32 (Step S34).

The signature recognition engine 32 compares the signature written by the user with the registered signature template in the EEPROM 21 or the internal exclusive use area C in the memory 13 (Step S35).

The signature recognition engine 32 determines whether the written signature is matched with the signature template from the comparison work at the process step of Step S35 (Step S36).

As described above, the removable storage device 1 conducts signature authentication according to the process steps of Step S21 and Steps S33 to S36.

In addition, at the process step of Step S25, Step S32 or Step S36, when the removable storage device 1 determines or identifies that the information inputted to the fingerprint sensor 10 is matched with the registered template beforehand, it grants the external device 2 access to the secure area B in the memory 13 as well as access to private keys stored in the EEPROM 21. In addition, at the process step of Step S25, Step S32 or Step S36, when the removable storage device 1 determines or identifies that the information inputted to the fingerprint sensor 10 is not matched with the registered template beforehand, it denies the external device 2 to access to the secure area B in the memory 13 as well as access to private keys stored in the EEPROM 21.

Here, authentication of a digital signature and forwarded text confirmation done by the removable storage device 1 according to PKI will be described.

In the EEPROM 21, private keys and public keys of PKI are stored. These keys are stored in two schemes in which they are externally recorded in advance and in which they are created and stored by the removable storage device 1 itself, but whichever schemes may be done.

When authentication and determination are successful at the process step of Step S25, Step S32 or Step S36, the removable storage device 1 can have access to the private keys stored in the EEPROM 21. The removable storage device 1 takes the hash value of text to make a signature, and encodes the hash value with a private key. Thus, a digital signature for a document to make a signature is completed.

In addition, similarly, when text is encoded that can be decoded by a person who made the text, a third party encodes the created text with a DES key, for example, and the DES key is encoded with a public key (which is provided for the person in advance).

Since the removable storage device 1 can have access to the private key stored in the EEPROM 21 when authentication and determination are successful at the process step of Step S25, Step S32 or Step S36, it can extract the DES key that encodes the text by decoding the encoded DES key with the private key. Then, the removable storage device 1 decodes cipher text with the extracted DES key.

In addition, in the removable storage device 1, for the authentication method, there are authentication according to a fingerprint, authentication according to a password, and authentication according to a signature. These schemes may be done in which access to the secure area B in the memory 13 is not granted when all the authentications are not matched, and in which access to the secure area B in the memory 13 is granted when any one of the authentications are is matched.

The removable storage device 1 thus configured has the fingerprint sensor 10, the authentication part 27 having the fingerprint recognition engine 30 configured to recognize the fingerprint read by the fingerprint sensor 10 and to compare it with a fingerprint template stored in the EEPROM 21 or the internal exclusive use area C in the memory 13 for verifying whether they are matched, the character recognition engine 31 configured to extract character and symbol information based on traces drawn on the fingerprint sensor 10 and to compare the extracted character and symbol information with a character and symbol template stored in the EEPROM 21 or the internal exclusive use area C in the memory 13 for verifying whether they are matched, and the signature recognition engine 32 configured to extract traces (signature) information based on the traces drawn on the fingerprint sensor 10 and to compare the extracted signature information with a signature template stored in the EEPROM 21 or the internal exclusive use area C in the memory 13 for verifying whether they are matched, and the authentication control part 28 configured to control the authentication part 27 which switches the authentication engines. Therefore, even when biometrics (fingerprint authentication) is not able to use, the authentication work can be completed by another authentication method, and personal authentication can be conducted fully separated from the external device 2 (self-contained type), whereby a remarkably high security system can be provided. In addition, a signature authentication having such a configuration may be done in which instead of the text input pen, a special seal is prepared to press the seal onto the fingerprint sensor 10 (seal authentication). The seal may be a unique, geometric pattern, for example.

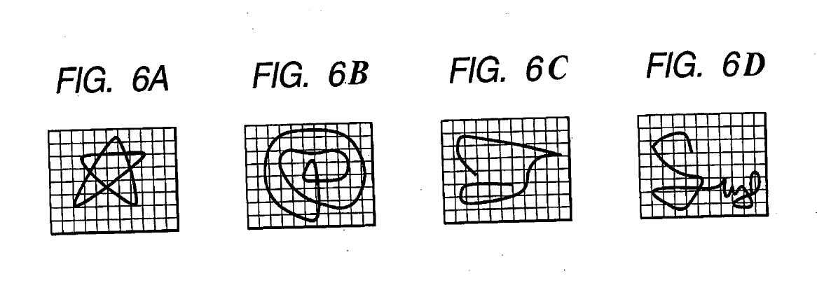

In addition, the removable storage device 1 may have a configuration provided with a storage part 40 configured to have given characters and symbols formed in a table in a given arrangement and stored therein (FIG. 8). In the case of the configuration, a character recognition engine 31 shows the descriptions of the table of the storage part 40 on a display part 11 in association with a finger moving on a fingerprint sensor 10.

For example, in the case of numbers “0 to 9” arranged in the table of the storage part 40, the character recognition engine 31 sequentially displays the numbers of 0 to 9 on the display part 11 when the finger vertically moves on the fingerprint sensor 10, whereas it determines the number currently displayed on the display part 11 and stores it in a password input register when the finger laterally moves on the fingerprint sensor 10. The character recognition engine 31 sequentially determines the numbers, and stores them in the password input register. When the finger touches at the same position twice on the fingerprint sensor 10, it determines that all the characters of a password are inputted. In addition, in the case of this configuration, the fingerprint sensor 10 may be configured of a line sensor, not the area sensor.

As described above, the removable storage device 1 according to an embodiment of the invention references to the table stored in the storage part 40 to register and input a password, whereby it has a merit that eliminates the text input pen.

It should be understood by those skilled in the art that various modifications, combinations, sub-combinations and alterations may occur depending on design requirements and other factors insofar as they are within the scope of the appended claims or the equivalents thereof.

What is claimed is:

1. A removable storage device comprising:
an interface which is defined by a predetermined format and to which an external device is connectable;
a data storage part in which data is stored and data is exchanged between the data storage part and the external device connected to the interface;
a fingerprint reading sensor configured to read a fingerprint;
authentication method selection means for selecting an authentication method;
first authentication means for verifying whether the fingerprint read by the fingerprint reading sensor is matched with a fingerprint registered beforehand by comparing them in accordance with the selection by the authentication method selection means;
second authentication means for verifying whether character and symbol information extracted based on traces drawn on the fingerprint reading sensor is matched with registered character and symbol information registered beforehand by comparing them in accordance with the selection by the authentication method selection means; and
determination means for determining whether to grant the external device access to the data storage part in accordance with an authentication result by the first authentication means or/and an authentication result by the second authentication means,
wherein the determination means grants the external device access to the data storage part when the first authentication means verifies that the fingerprint is matched, or/and the second authentication means verifies that character information is matched.

2. The removable storage device according to claim 1, further comprising third authentication means for verifying whether trace information extracted based on traces drawn on the fingerprint reading sensor is matched with trace information registered beforehand by comparing them in accordance with the selection by the authentication method selection means,
wherein the determination means determines whether to grant the external device access to the data storage part in accordance with an authentication result by the first authentication means, an authentication result by the second authentication means, or/and an authentication result by the third authentication means.

3. The removable storage device according to claim 1, further comprising display means for displaying character and symbol information extracted based on traces drawn on the fingerprint reading sensor.

4. The removable storage device according to claim 1, wherein the fingerprint reading sensor is configured of an area sensor having a predetermined size, which is configured of a trace drawing area in which a trace is drawn and a determination area which determines a character or a symbol that is drawn in the trace drawing area.

5. The removable storage device according to claim 1, further comprising storing means for storing a table in which given characters and symbols are arranged in a given arrangement.

6. The removable storage device according to claim 5, wherein the second authentication means selects a matched character or symbol from the table based on a trace pattern drawn on the fingerprint sensor in accordance with the selection by the authentication method selection means, and verifies whether the selected character or symbol is matched with character and symbol information registered beforehand.

7. The removable storage device according to claim 5, wherein when the fingerprint reading sensor is configured of a line sensor, the second authentication means selects a matched character or symbol from the table based on contact directions drawn on the fingerprint sensor in accordance with the selection by the authentication method selection means, and verifies whether the selected character or symbol is matched with character and symbol information registered beforehand.

8. An authentication method of authenticating whether data is allowed to be exchanged between a removable storage device having an interface defined by a predetermined format and a data storage part in which data is stored and an external device connected to the interface, the authentication method comprising:
a step of selecting an authentication method;
a first authentication step of verifying whether a fingerprint read by a fingerprint reading sensor which reads a fingerprint is matched with a fingerprint registered beforehand by comparing them in accordance with the selection in the step of selecting an authentication method;
a second authentication step of verifying whether character and symbol information extracted based on traces drawn on the fingerprint reading sensor is matched with registered character and symbol information registered beforehand by comparing them in accordance with the selection by the authentication method selecting step; and
a determining step of determining whether to grant the external device access to the data storage part in accordance with an authentication result by the first authentication step or/and an authentication result by the second authentication step,
wherein the determining step grants the external device access to the data storage part when the first authentication step verifies that the fingerprint is matched, or/and the second authentication step verifies that character information is matched.

9. A removable storage device comprising:
an interface which is defined by a predetermined format and to which an external device is connectable;
a data storage part in which data is stored and data is exchanged between the data storage part and the external device connected to the interface;
a fingerprint reading sensor configured to read a fingerprint;
an authentication method selection unit configured to select an authentication method;
a first authentication unit configured to verify whether the fingerprint read by the fingerprint reading sensor is matched with a fingerprint registered beforehand by comparing them in accordance with the selection by the authentication method selection unit;
a second authentication unit configured to verify whether character and symbol information extracted based on traces drawn on the fingerprint reading sensor is matched with registered character and symbol information registered beforehand by comparing them in accordance with the selection by the authentication method selection unit; and
a determination unit configured to determine whether to grant the external device access to the data storage part in accordance with an authentication result by the first authentication unit or/and an authentication result by the second authentication unit,
wherein the determination unit grants the external device access to the data storage part when the first authentication unit verifies that the fingerprint is matched, or/and the second authentication unit verifies that character information is matched.
